(19) United States
(12) Patent Application Publication
(10) Pub. No.: US 2025/0038178 A1
(43) Pub. Date: Jan. 30, 2025

(54) RECYCLED ELECTRODE ACTIVE MATERIAL COMPOSITION MANUFACTURED FROM WASTE BATTERIES AND METHOD FOR MANUFACTURING THEREOF

(71) Applicants: Hyundai Motor Company, Seoul (KR); Kia Corporation, Seoul (KR)

(72) Inventors: Im Sul Seo, Cheongju-si (KR); Hong-Seok Min, Yongin-si (KR); Sung Woo Noh, Seoul (KR); Jeong Hyun Seo, Daejeon (KR); Chung Bum Lim, Suwon-si (KR); Ju Yeong Seong, Seongnam-si (KR); Je Sik Park, Seoul (KR)

(21) Appl. No.: 18/404,297

(22) Filed: Jan. 4, 2024

(30) Foreign Application Priority Data
Jul. 24, 2023 (KR) 10-2023-0095789

(51) Int. Cl. H01M 4/36; H01M 4/04; H01M 10/54

(52) U.S. Cl. CPC H01M 4/366; H01M 4/0471; H01M 10/54; H01M 2004/021; H01M 2004/028; H01M 4/525; H01M 4/5825

(57) ABSTRACT

An embodiment regenerated cathode active material includes a first core region including a cathode active material in a layered crystal structure and a second core region enveloping a portion of the first core region, wherein the regenerated cathode active material has a first mole fraction of particles in the layered crystal structure of 0.96 to 1, has a second mole fraction of particles in a rock salt crystal structure of 0 to 0.02, and has a third mole fraction of particles in a spinel crystal structure of 0 to 0.02 based on the total cathode active material.

### CROSS-REFERENCE TO RELATED APPLICATIONS

This application claims the benefit of Korean Patent Application No. 10-2023-0095789, filed on Jul. 24, 2023, which application is hereby incorporated herein by reference.

### TECHNICAL FIELD

The present disclosure relates to a regenerated cathode active material produced from a waste battery and a method for preparing the same.

### BACKGROUND

Since the secondary battery industry is positioned as a core technology in various application fields such as smart phones, tablet PCs, electric vehicles, and energy storage devices, its industrial importance is increasing. Secondary batteries, which are mainly applied to portable electronic devices, are being actively researched and developed as concerns about the global environment and fossil fuel depletion grow, and it is expected that the demand amount for secondary batteries will also further increase as the electric vehicle market expands in the future. Since a defective waste battery scrap or a waste cathode material generated during the secondary battery manufacturing process, or a secondary battery waste scrap (e.g., black powder) discarded after use, contains useful metals such as nickel (Ni), cobalt (Co), and manganese (Mn), technology development for recovering and recycling such useful resources has recently been actively progressed.

However, waste battery materials include substances such as carbon and other metals, metal oxides, and binders used in the battery manufacturing process, and since these may act as inhibition factors in recovering valuable metals, continuous research is being conducted on optimal technologies that can efficiently recover valuable metals. Since nickel-cobalt-manganese composite metal oxide cathode materials, which account for 60% or more of the cost of secondary batteries, have no difference between pure materials and substances refined/recovered through recycling of waste scraps, secondary battery recycling is expected to be positioned as an indispensable technology as the scale of the medium and large-sized battery market expands, not only from the viewpoint of resource circulation but also from the viewpoint of securing cost stability of secondary batteries.

In particular, a technology of recovering lithium from waste electrode materials includes a technology of pre-extraction by a dry smelting process based on reduction heat treatment and a technology of post-extracting lithium after the separation/refining of nickel, cobalt, and manganese through a hydrometallurgical process based on solvent extraction. Since a commonly used technology among these includes hydrometallurgy, leaching, and solvent extraction processes, it not only may have poor lithium recovery efficiency, but it also may cause environmental problems such as ecotoxicity due to lithium remaining when wastewater is discharged.

Meanwhile, since only a physical screening process is performed for a short time in the pretreatment process in the conventional battery recycling method, the cathode active material in black powder (BP), which is the primary screening material, maintains the existing layered structure or shows local deterioration of the surface portion. In addition, maintaining the crystal structure of the cathode active material is not greatly important since the black powder is leached into strong acid in the secondary screening process (post-treatment) of extracting target elements such as Ni, Co, and Mn. Recently, direct recycling methods in which post-treatment (leaching or element extraction) is omitted have been studied, and accordingly, the layered structure of the cathode active material in the black powder is recovered without damaging it in the pre-treatment step so that lithiation may be performed sometimes.

However, according to the conventional method, there are problems in that the recovery rate and purity of the black powder are low, and the process is complicated so that a lot of time and cost are required for recycling, and thus it is necessary to develop a technology that can overcome these problems.

### SUMMARY

Embodiments of the present disclosure can solve problems in the art, and an embodiment of the present disclosure provides a regenerated cathode active material having a core-shell structure in which the cathode active material formed in a layered structure through solvent treatment and heating firing treatment has a mole fraction of 96% or more.

Another embodiment of the present disclosure provides a method for preparing a regenerated cathode active material, which includes a process of efficiently separating the cathode active material through a volume change caused by treating a waste battery with a solvent and thus contracting/relaxing a binder of the waste battery.

The embodiments of the present disclosure are not limited to the embodiments mentioned above. The embodiments of the present disclosure will become more apparent from the following description and will be realized by means and combinations thereof described in the claims.

One embodiment of the present disclosure relates to a regenerated cathode active material including a first core region having a cathode active material in a layered crystal structure and a second core region enveloping at least a portion of the first core region.

The regenerated cathode active material may have a mole fraction of particles formed in a layered crystal structure of 0.96 to 1, a mole fraction of particles formed in a rock salt crystal structure of 0 to 0.02, and a mole fraction of particles formed in a spinel crystal structure of 0 to 0.02 based on the total cathode active material.

The second core region may include a first metal element.

The first metal element may include at least one selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W).

The concentration gradient of the first metal element in the cathode active material may rise in a stepwise manner based on the boundary surface between the first core region and the second core region from the center of the first core region and may gradually rise from the boundary surface of the second core region toward the outer direction of the second core region.

The regenerated cathode active material may further include a first reinforcement layer enveloping at least a portion of the second core region.

The first reinforcement layer may include a first metal element.

The first reinforcement layer may be at least one selected from the group consisting of B₂O₃, Li₂O—B₂O₃, Li₃BO₃, Li₂B₄O₇, Li₂B₂O₇, and Li₂B₈O₁₃.

The first reinforcement layer may have a thickness of 1 to 100 nm.

The regenerated cathode active material may have a specific surface area of 1.5 m²/g or less.

The regenerated cathode active material may have a particle strength of 80 MPa or more.

The content of the residual lithium by-product in the regenerated cathode active material may be less than 1.5% by weight based on the total weight of the cathode active material.

The regenerated cathode active material may further include a second reinforcement layer enveloping at least a portion of the first reinforcement layer, and the second reinforcement layer may include a second metal element.

The second metal element may include at least one selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W).

Another embodiment of the present disclosure relates to a method for preparing a regenerated cathode active material including mixing a waste battery crushed to the first particle size with a solvent after crushing the waste battery to the first particle size, first precipitating the mixture, second precipitating the first precipitate after crushing the first precipitate to a second particle size, pressurizing the second precipitate so that a second precipitate has a moisture content of a predetermined % or less, obtaining a black powder containing a waste cathode active material by drying the pressurized second precipitate, and performing a primary heat treatment after mixing the black powder with a lithium precursor.

The waste battery may include, for example, at least one selected from the group consisting of scrap generated in a cathode active material preparation process, scrap generated in a cell process, and a waste battery, but is not limited thereto.

The waste battery may include at least one selected from the group consisting of lithium nickel cobalt manganese oxide (LiNiCoMnO₂; NCM), lithium nickel cobalt aluminum oxide (LiNICOAlO₂; NCA), lithium iron phosphate (LiFePO₄; LFP), lithium manganese iron phosphate (LiMnFePO₄; LMFP), lithium manganese oxide (LiMn₂O₄; LMO), lithium nickel manganese spinel (LiNi_{0.5}Mn_{1.5}O₄; LNMO), and lithium cobalt oxide (LiCoO₂; LCO) series.

The cathode active material is a cathode active material for a lithium secondary battery obtained from the waste battery and includes lithium (Li), but may include cobalt (Co), nickel (Ni), aluminum (Al), iron (Fe), manganese (Mn), oxides thereof, and combinations thereof.

The solvent may include at least one selected from the group consisting of water, methanol, ethanol, and acetonitrile.

The mixing the waste battery crushed to the first particle size with a solvent may be performed at 60 to 100° C.

The mixing the waste battery crushed to the first particle size with a solvent may be performed for 2 to 24 hours.

The first particle size may be 0.5 to 10 cm.

The second particle size may be 0.01 to 0.5 cm.

The second precipitate may have a particle size of 0.1 to 100 μm.

The drying may be performed at 80 to 140° C.

The drying may be performed for 1 to 14 hours.

The performing a primary heat treatment may be mixing 1 to 30% by weight of a lithium precursor based on the total weight of the black powder.

The performing a primary heat treatment may be performed for 3 to 24 hours.

The performing a primary heat treatment may be performed at 200 to 1,000° C.

The performing a primary heat treatment may be performed in an oxygen atmosphere.

In one embodiment, the performing a primary heat treatment may include performing the primary heat treatment after mixing the black powder with the lithium precursor and the first metal element precursor. The first metal element may be doped on a waste cathode active material through this.

In one embodiment, in performing a primary heat treatment, 0.1 to 10% by weight of the first metal element precursor may be mixed based on the total weight of the black powder.

The preparation method may include the steps of crushing a primary heat treatment resulting product and mixing the crushed primary heat treatment resulting product with a second metal element and performing a secondary heat treatment.

The performing a secondary heat treatment may be performed for 3 to 18 hours.

The performing a secondary heat treatment may be performed at 200 to 800° C.

The performing a secondary heat treatment may be performed in an oxygen atmosphere.

The cathode active material according to embodiments of the present disclosure is a core-shell structure in which the cathode active material formed in a layered structure has a mole fraction of at least 96% and has excellent physical properties such as initial capacity, lifespan, electrochemical properties, particle strength, etc.

Further, if the method for preparing a regenerated cathode active material according to embodiments of the present disclosure is used, a cathode mixture can be directly and efficiently separated from a waste battery, and a change in the chain structure of polyvinylidene fluoride (PVdF) in the binder can be induced, thereby increasing the purity, the recovery efficiency, and the process speed of the black powder through the contraction of the mixture.

The effects of embodiments of the present disclosure are not limited to the above-mentioned effects. It should be understood that the effects of embodiments of the present disclosure include all effects that can be inferred from the following description.

### BRIEF DESCRIPTION OF THE DRAWINGS

FIG. 1 shows a method for preparing a regenerated cathode active material according to one example of an embodiment of the present disclosure.

FIG. 2 is a schematic diagram showing a cross-sectional structure of a cathode active material according to one comparative example of an embodiment of the present disclosure.

FIG. 3 is a schematic diagram showing a cross-sectional structure of a regenerated cathode active material according to one example of an embodiment of the present disclosure.

FIG. 4 is a schematic diagram showing a cross-sectional structure of a regenerated cathode active material doped with a first metal element according to one example of an embodiment of the present disclosure.

FIG. 5 is a schematic diagram showing a cross-sectional structure of a regenerated cathode active material coated with a second metal element according to one example of an embodiment of the present disclosure.

FIG. 6 is a graph showing a concentration gradient of a doped metal element in a regenerated cathode active material according to one example of an embodiment of the present disclosure.

FIG. 7 is a three-phase diagram showing phase distribution ranges of the cathode active materials of Examples 1 and 2 and Comparative Example 1.

### DETAILED DESCRIPTION OF ILLUSTRATIVE EMBODIMENTS

The above objects, other objects, features, and advantages of embodiments of the present disclosure will be easily understood through the following preferred embodiments related to the accompanying drawings. However, the embodiments of the present disclosure are not limited to the embodiments described herein and may be embodied in other forms. Rather, the embodiments introduced herein are provided so that the disclosed content may become thorough and complete, and the spirit of the embodiments of the present disclosure may be sufficiently conveyed to those skilled in the art.

The similar reference numerals have been used for similar elements while explaining each drawing. In the accompanying drawings, dimensions of the structures are shown larger than actual for clarity of embodiments of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of embodiments of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” another part, this includes not only the case where it is “directly on” the other part, but also the case where there is another part in the middle therebetween. Conversely, when a part of a layer, film, region, plate, etc. is said to be “under” another part, this includes not only the case where it is “directly under” the other part, but also the case where there is another part in the middle therebetween.

Unless otherwise specified, since all numbers, values, and/or expressions expressing quantities of components, reaction conditions, polymer compositions, and formulations used in the present specification are approximate values reflecting various uncertainties of the measurement that arise in obtaining these values among others in which these numbers are essentially different, they should be understood as being modified by the term “about” in all cases. Further, when a numerical range is disclosed in this description, such a range is continuous and includes all values from a minimum value of such a range to a maximum value including the maximum value, unless otherwise indicated. Furthermore, when such a range refers to an integer, all integers including from the minimum value to the maximum value including the maximum value are included, unless otherwise indicated.

In this specification, where ranges are stated for a variable, it will be understood that the variable includes all values within the stated range including the stated endpoints of the range. For example, a range of “5 to 10” includes any subrange of 6 to 10, 7 to 10, 6 to 9, 7 to 9, and the like as well as values of 5, 6, 7, 8, 9, and 10, and it will also be understood to include any value between integers that are valid for the scope of the stated range, such as 5.5, 6.5, 7.5, 5.5 to 8.5, 6.5 to 9, and the like. Also, for example, the range of “10% to 30%” includes any sub-range of 10% to 15%, 12% to 18%, 20% to 30%, and the like as well as values such as 10%, 11%, 12%, 13%, and the like, and all integers including up to 30%, and it will also be understood to include any value between integers that are valid for the scope of the stated range, such as 10.5%, 15.5%, 25.5%, and the like.

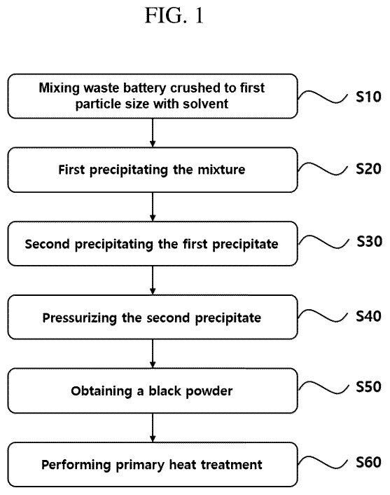

FIG. 1 shows a method for preparing a regenerated cathode active material according to one example of an embodiment of the present disclosure, and the method for preparing a regenerated cathode active material may include mixing a waste battery crushed to a first particle size with a solvent after crushing the waste battery to the first particle size (S10), first precipitating the mixture (S20), second precipitating the first precipitate after crushing the first precipitate to a second particle size (S30), pressurizing the second precipitate so that the second precipitate has a moisture content of a predetermined % or less (S40), obtaining a black powder by drying the pressurized second precipitate (S50), and performing a primary heat treatment after mixing the black powder with a lithium precursor (S60).

The waste battery may include at least one selected from the group consisting of lithium nickel cobalt manganese oxide (LiNiCoMnO₂; NCM), lithium nickel cobalt aluminum oxide (LiNiCoAlO₂; NCA), lithium iron phosphate (LiFePO₄; LFP), lithium manganese iron phosphate (LiMnFePO₄; LMFP), lithium manganese oxide (LiMn₂O₄; LMO), lithium nickel manganese spinel (LiNi_{0.5}Mn_{1.5}O₄; LNMO), and lithium cobalt oxide (LiCoO₂; LCO) series, and the waste battery may include, for example, lithium nickel cobalt manganese oxide (NCM), but it is not limited thereto.

The solvent may include at least one selected from the group consisting of water, methanol, ethanol, and acetonitrile, but it is not limited thereto. The solvent may include n-th distilled water, and may include, for example, first distilled water, but it is not limited thereto.

In the step (S10) of mixing the waste battery crushed to the first particle size with a solvent, the waste battery may be crushed to the first particle size, and the first particle size may be 0.5 to 10 cm, but it is not limited thereto.

The step (S10) of mixing the waste battery crushed to the first particle size with a solvent is mixing the crushed waste battery with the solvent, and it may be performed at 60 to 100° C. Since the peelability of the cathode mixture is increased when the mixing the waste battery crushed to the first particle size with the solvent is performed in a range of 60 to 100° C., the recovery rate of the cathode active material may be increased and process efficiency may be improved.

The step (S10) of mixing the waste battery crushed to the first particle size with a solvent may be performed for 2 to 24 hours, and it may be performed, for example, for 10 hours, but it is not limited thereto.

The step (S20) of first precipitating the mixture may be precipitating a primary precipitate including the cathode mixture from the waste battery crushed to the first particle size in the mixture through impeller stirring. The step (S20) of first precipitating the mixture may be stirring the mixture at 500 rpm, but it is not limited thereto.

The cathode mixture may include a cathode active material and impurities other than the cathode active material.

The step (S30) of second precipitating may be precipitating a second precipitate including a waste cathode material from the first precipitate crushed to a second particle size.

The waste cathode material may include a cathode active material remaining after impurities other than the cathode active material are removed from the cathode mixture.

In the step (S30) of second precipitating, the first precipitate may be crushed to a second particle size, and the second particle size may be 0.01 to 0.5 cm, but it is not limited thereto.

The step (S30) of second precipitating may be performed using ultrasonic waves.

The step (S30) of second precipitating may include filtering the second precipitate, and the filtering step may be performed using a mesh network having pores of a predetermined size. Through this, it is possible to selectively filter out only the particles of the waste cathode active material of a predetermined size from the second precipitate, and since the particle diameter of the finally produced regenerated cathode active material becomes uniform, the quality can be further improved.

The step (S40) of pressurizing may be pressurizing the second precipitate so that the second precipitate has a moisture content of a predetermined % or less. The moisture content may be, for example, 10%, 15%, 20%, 25%, or 30%, but it is not limited thereto.

The step (S40) of pressurizing may be performed using, for example, a filter press device, but it is not limited thereto.

The step (S50) of obtaining a black powder may be obtaining a black powder (BP) containing the waste cathode active material by drying the pressurized second precipitate.

The drying may be performed at 80 to 140° C. for 1 to 14 hours, but it is not limited thereto.

The obtained black powder may include a waste cathode active material which has an original layered crystal structure in the central portion thereof and is degraded into a spinel crystal structure and/or rock salt crystal structure by a predetermined depth on the outside thereof.

The step (S60) of performing a primary heat treatment may be performing a primary heat treatment after mixing a black powder containing the waste cathode active material with a lithium precursor. The step of performing a primary heat treatment may be performing re-lithiation (or lithiation) of the waste cathode active material with a lithium precursor.

The step (S60) of performing a primary heat treatment may include mixing 1 to 30% by weight of the lithium precursor with respect to the total weight of the black powder.

The lithium precursor may be at least one selected from the group consisting of lithium oxide, lithium carbonate, lithium chloride, lithium sulfide, lithium nitrate, lithium phosphate, and lithium hydroxide, and may be, for example, lithium hydroxide, but it is not limited thereto.

In the step (S60) of performing a primary heat treatment, the black powder and the lithium precursor may be mixed at 1,000 rpm to 2,000 rpm, but it is not limited thereto.

In the step (S60) of performing a primary heat treatment, a stirring time may be 1 minute to 30 minutes, but it is not limited thereto.

Lithium loss of the waste cathode active material included in the black powder may be compensated for through the step (S60) of performing a primary heat treatment. Here, compensation for lithium loss may mean increasing the molar ratio of lithium to transition metal in the waste cathode active material, which has decreased to a range of 1:0.1 or more to less than 1:0.9, to 1:0.9 to 1:1. When the molar ratio of lithium to transition metal in the waste cathode active material is compensated within the corresponding range, physical properties such as initial capacity, lifespan, electrochemical properties, and particle strength of the regenerated cathode active material may become excellent.

The step (S60) of performing a primary heat treatment may be performed at 200° C. to 1,000° C. for 3 hours to 24 hours, and may be performed, for example, at 700° C. for 12 hours.

The step (S60) of performing a primary heat treatment may be performed in an oxygen (O₂) atmosphere.

The regenerated cathode active material prepared through the step (S60) of performing a primary heat treatment may form a structure of the first core region 10 and the second core region 20 so that the first core region is surrounded by the second core region 20, wherein the second core region 20 may be a region in which lithium is compensated for in a deterioration region of the waste cathode active material.

In one embodiment, the step (S60) of performing a primary heat treatment may include performing heat treatment after mixing the black powder containing the waste cathode active material with the lithium precursor and the first metal element precursor. Through this, the waste cathode active material may be doped with a first metal element.

In this specification, the term ‘doping’ may refer to a process of changing the characteristics of the particles by adding other atoms or ions to any particles, and it may be for imparting desired properties to any particles by controlling conductivity, magnetism, optical properties, etc.

The first metal element may include at least one selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W), and may be, for example, boron, but it is not limited thereto.

The regenerated cathode active material doped with the first metal element may form a structure of the first core region 10, the second core region 20, and the first reinforcement layer 30. The second core region 20 may be a region in which a deterioration region of the waste cathode material is compensated for with lithium and which is simultaneously doped with a first metal element. The first reinforcement layer 30 may refer to a layer which is formed by surrounding the second core region 20 with the first metal element. The first reinforcement layer 30 may include a lithium borate-based compound or a borate-based compound, and the lithium borate-based compound or the borate-based compound may include B₂O₃, Li₂O—B₂O₃, Li₃BO₃, Li₂B₄O₇, Li₂B₂O₇, Li₂B₈O₁₃, etc. The first reinforcement layer 30 may have a thickness of 1 to 100 nm. The first reinforcement layer 30 may serve as a cathode electrolyte interphase (CEI) layer by enclosing the second core region 20 to increase structural stability of the cathode active material and to impart ionic conductivity at the same time. Through this, the regenerated cathode active material of embodiments of the present disclosure may suppress side reactions with the electrolyte and exhibit high battery capacity and life retention rate.

In one embodiment, in the step of performing a primary heat treatment, 0.1 to 10% by weight of the first metal element precursor may be mixed based on the total weight of the black powder.

The first reinforcement layer of the regenerated cathode active material may have a thickness of 1 to 100 nm. The regenerated cathode active material on which the first reinforcement layer is formed may have a specific surface area of 1.5 m²/g or less, and it may have a particle strength of 80 MPa or more. The amount of a residual lithium by-product in the regenerated cathode active material having the first reinforcing layer formed thereon may be less than 1.5% by weight based on the total weight of the cathode active material. The residual lithium by-product may refer to a lithium by-product present in the form of LiOH, Li₂CO₃, etc. on the surface of the regenerated cathode active material, and when the residual amount of the lithium by-product is high, gas generation and swelling may occur due to this.

The preparation method may include a step of crushing a primary heat treatment resulting product, mixing the crushed primary heat treatment resulting product with a second metal element, and then performing a secondary heat treatment (not shown).

The second metal element may include at least one selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W), and may be, for example, tungsten, but it is not limited thereto.

In the step of performing a secondary heat treatment, the crushed primary heat treatment resulting product and the second metal element may be mixed at 1,000 rpm to 2,000 rpm, but it is not limited thereto.

In the step of performing a secondary heat treatment, a stirring time may be 1 minute to 30 minutes, but it is not limited thereto.

The step of performing a secondary heat treatment may be performed at 200° C. to 800° C. for 3 hours to 18 hours, and it may be performed, for example, at 350° C. for 10 hours.

The step of performing a secondary heat treatment may be performed in an oxygen (O₂) atmosphere.

Through the step of performing a secondary heat treatment, a second reinforcement layer enveloping at least a portion of the first reinforcement layer may be formed with respect to the regenerated cathode active material including a first core region-second core region-first reinforcement layer structure. In one embodiment, the second reinforcement layer may include tungsten (W). Through this, the cathode active material according to embodiments of the present disclosure forms a dense core-shell structure so that battery properties such as battery lifespan, particle strength, etc. may be further improved.

The method for preparing a regenerated cathode active material may include a content substantially overlapping with the content of the regenerated cathode active material described above, and description of the overlapping portion may be omitted.

The form of embodiments of the present disclosure will be described in more detail through a Preparation Example and Examples below. The following Preparation Example and Examples are only examples to aid understanding of embodiments of the present disclosure, and the scope of the embodiments of the present disclosure is not limited thereto.

### 1. PREPARATION EXAMPLE

### 1-1. Comparative Example 1

0.5 to 10 cm flakes prepared after crushing a lithium nickel cobalt manganese oxide waste battery (base material: Ni=85%, NCM, 11 μm (D50)) were injected into 70° C. distilled water. A cathode mixture containing some impurities was separated and precipitated through impeller stirring in a water bath. The precipitated cathode mixture was pulverized to a size of 0.01 to 0.5 cm, the waste cathode material was separated and precipitated using ultrasonic waves, and moisture was removed using a filter press so that the precipitated waste cathode material had a moisture content of 15% or less. (Stirring conditions: 10 hours, 500 rpm.)

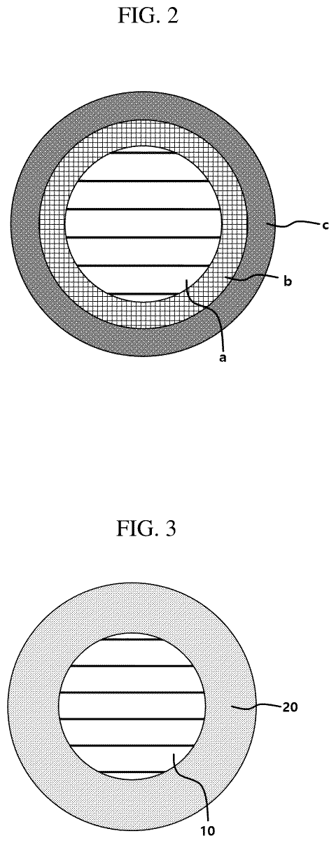

The waste cathode material from which moisture was removed was dried at 120° C. for 12 hours, and thus a black powder having a three-phase crystal structure of a layered structure, a spinel structure (deterioration structure 1), and a rock salt structure (deterioration structure 2) was obtained so that its schematic diagram is shown in FIG. 2.

Referring to FIG. 2, when examining the cross-section of the crystal structure of Comparative Example 1, it can be confirmed that it includes a core (a) of a layered structure, a deterioration layer (b) of a spinel structure enveloping the core, and a deterioration layer (c) of a rock salt structure enveloping the deterioration layer (b).

Here, the layered structure may belong to the R3-M space group. The spinel structure may belong to the Fd-3m space group. The spinel structure means that a metal oxide layer composed of a transition metal and oxygen and an oxygen octahedral layer surrounding lithium have a three-dimensional arrangement. The rock salt structure may belong to the Fm3m space group. The rock salt structure means a face centered cubic structure in which metal atoms are coordinated by 6 oxygen atoms located in an octahedral shape around the metal atoms.

### 1-2. Example 1

In order to reproduce the cross-sectional structure of the black powder of Comparative Example 1 as a single layer, the black powder and 20% by weight of lithium hydroxide (LiOH) as a lithium precursor based on the total weight of the black powder were mixed and stirred at 1,400 rpm for 10 minutes. Thereafter, the stirred mixture was heat-treated at 700° C. in an oxygen atmosphere for 12 hours, and the crystal structure thereof is shown in FIG. 3.

Referring to FIG. 3, it can be confirmed that the regenerated cathode active material of Example 1 includes a first core region 10 having a layered crystal structure and a second core region 20 which envelopes at least a portion of the outer side of the first core region 10 and in which lithium is compensated for the conventional deterioration layer that could be confirmed in Comparative Example 1 so as to have a layered crystal structure.

### 1-3. Example 2

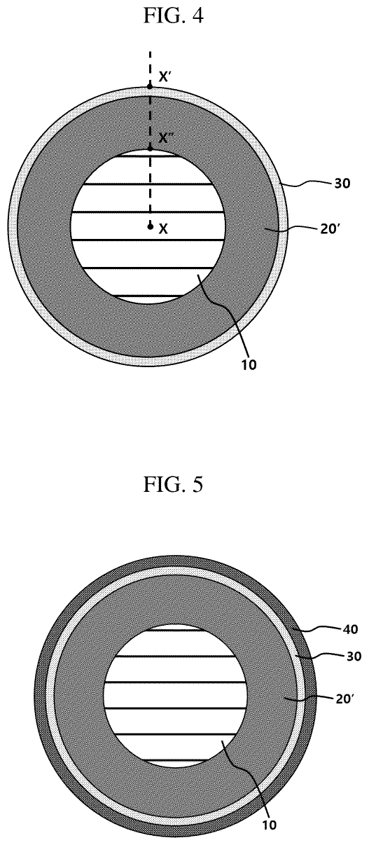

The black powder of Comparative Example 1, 20% by weight of lithium hydroxide (LiOH) based on the total weight of the black powder, and 0.8% by weight of boric acid (H₃BO₃) as a first metal element precursor based on the total weight of the black powder were mixed, and besides, the mixture was stirred and subjected to heat treatment in the same manner as in the preparation process of Example 1 to prepare a regenerated cathode active material of Example 2. A cross section of the crystal structure of the regenerated cathode active material of Example 2 is shown in FIG. 4.

Referring to FIG. 4, it can be confirmed that the regenerated cathode active material of Example 2 includes a first core region 10 having a layered structure, a second core region 20′ which envelopes the first core region 10, is compensated with lithium, and is doped with a first metal element (boron, B), and a first reinforcement layer 30 enveloping the second core region 20 and including the first metal element. The doping depth (X′-X″) of the second core region 20 doped with the first metal element may correspond to a maximum of 80% of the radius (X-X′) of the regenerated cathode active material of Example 2.

### 1-4. Example 3

The regenerated cathode active material of Example 2 was additionally mixed with a second metal element (tungsten, W) and then heat-treated to prepare the regenerated cathode active material of Example 3, and its cross-sectional structure is shown in FIG. 5. The mixing was performed at 1,000 rpm to 2,000 rpm for 1 minute to 30 minutes. The heat treatment was performed in an oxygen atmosphere at 200 to 800° C. for 3 to 18 hours.

Referring to FIG. 5, it can be confirmed that the regenerated cathode active material of Example 3 has a second reinforcement layer 40 formed outside the first reinforcement layer 30, and through this, the regenerated cathode active material according to embodiments of the present disclosure forms a dense core-shell structure through the first core region (Core 1), the second core region (Core 2), the first reinforcement layer (Shell 1), and the second reinforcement layer (Shell 2) so that battery properties such as battery lifespan, particle strength, etc. may be further improved.

### 2. Experimental Example

### 2-1. Physical Property Evaluation

Physical properties of the cathode active materials of Comparative Example 1 and Examples 1 and 2 were measured and are shown in Table 1.

TABLE 1

| | | | | Particle | | | Specific | | | Lifespan | |
|---|---|---|---|---|---|---|---|---|---|---|---|
| | Crystal phase fraction (%) | | | size | Doping | Particle | surface | 0.1 C | 0.5 C | retention | |
| | Layered- | | Rock | (D50) | depth | strength | area | capacity | rate | rate | AC-IR |
| Item | shape | Spinel | salt | (μm) | (μm) | (MPa) | (m²/g) | (mAh/g) | (%) | (%, 50^{th}) | (Ω) |
| Example 1 | 98.7 | 0.9 | 0.4 | 10.8 | — | 108.4 | 0.3 | 209.1 | 87.1 | 83.6 | 20.5 |
| Example 2 | 99.1 | 0.7 | 0.2 | 10.8 | 3.8 | 122.0 | 0.3 | 219.4 | 93.3 | 92.4 | 14.2 |
| Comparative | 62.2 | 27.7 | 10.1 | 10.8 | — | 54.1 | 1.2 | — | — | — | 917.3 |
| Example 1 | | | | | | | | | | | |

The evaluation of charge and discharge related to capacity, rate, and lifespan is based on results of measuring LIB coin cells composed of liquid organic electrolytes (EC/EMC) at 3.0 to 4.3 V and 25° C.

### Terminology:

Phase fraction: mole fraction of the crystalline phase calculated through X-ray structural analysis;

Doping depth: depth at which the second doping element is distributed from the particle surface to the central direction;

Particle strength: breaking strength when performing compression pressurization for one particle;

Capacity: initial capacity under 0.1C/0.1C charging and discharging conditions; and

Lifespan retention rate: capacity retention rate after 50 cycles of lifespan under 0.5C/0.5C charging and discharging conditions.

Referring to Table 1, it can be confirmed that the phase fraction of the layered crystal structure was improved to 98.7% in Example 1 and 99.1% in Example 2 in which the deteriorated region was relithiated, unlike Comparative Example 1 in which it was 62.2%, and both of the spinel crystal structure and rock salt crystal structure have the phase fractions of less than 1%.

The doping depth in Example 2 was shown to be 3.8 μm so that it can be seen that the second core region 20 of the cathode active material according to embodiments of the present disclosure had a thickness of about 3.8 μm. In particular, due to this, the particle strength of Example 2 was measured to be 122.0 Mpa, which was improved by +12.5% compared to the particle strength of Example 1 which was 108.4 MPa.

In addition, it could be confirmed that Example 2 had excellent durability and battery performance based on the fact that Example 2 showed higher values in terms of specific surface area, 0.1C capacity, 0.5C rate, and lifespan retention rate compared to Example 1.

### 2-2. Concentration Gradients of Metal Elements

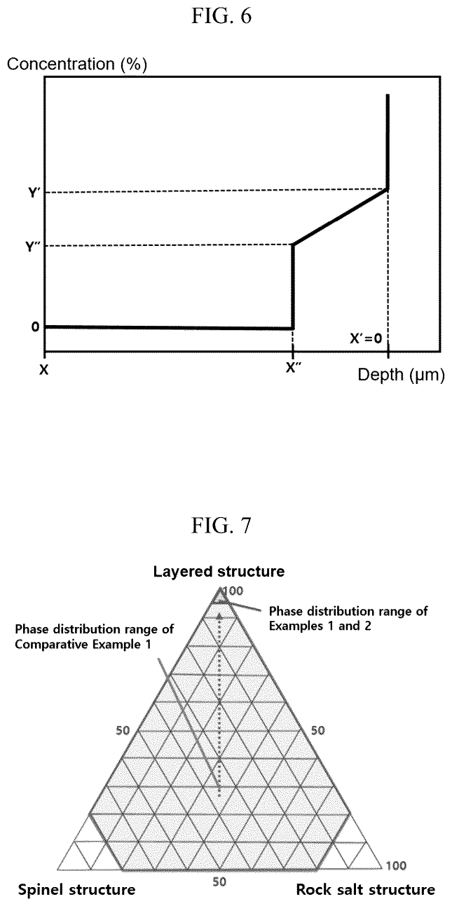

The concentration gradients of the first metal element doped up to the point (X′), which is the shortest distance from the center (X) of the first core region 10 to the surface of the first reinforcement layer 30 outside the cathode active material, are shown in FIG. 6.

Referring to FIG. 6, the central portion X of the first core region 10 maintained a very low concentration level in which the concentration of the doped first metal element approaches o and the concentration of the metal element is o or approaches o until a boundary surface point X″ between the first core region 10 and the second core region 20, but a stepwise concentration gradient could be confirmed since the concentration rapidly increased to Y″ from the boundary surface point X″. In addition, it can be confirmed that the concentration of the first metal element to be doped is gradually increased from Y″ to Y′ as it goes from the interface surface point X″ toward the outer direction X′ of the second core region 20.

Accordingly, the concentration gradient of the first metal element rises in a stepwise manner from the center of the first core region 10 in the regenerated cathode active material toward the outer direction of the second core region 20 based on the boundary surface of the second core region 20. However, it showed an appearance gradually rising from the boundary surface of the second core region 20 toward the outer direction.

### 2-3. Phase Distribution of Cathode Active Material

FIG. 7 is a three-phase diagram showing phase distribution ranges of the cathode active materials.

Referring to this, since the cathode active material of Comparative Example 1 had higher mole fractions of spinel structure particles and rock salt structure particles than those of Examples 1 and 2, and the regenerated cathode active materials of Examples 1 and 2 of embodiments of the present disclosure had a mole fraction of layered structure particles of 98% or more, they were located biased toward the layered structure as can be confirmed on the three-phase diagram.

According to this, when Comparative Example 1 is expressed as three-phase mole fraction phase (%, deterioration structure)=layered structure (x): spinel structure (y): rock salt structure (z), it may be expressed as 100>x>0, 80≥y >0, 80≥z >0, which corresponds to the shaded region on the three-phase diagram of FIG. 7. Comparative Example 1 with such a deterioration structure exhibits electrochemical performance reduced to about 50% or less of that of the existing normal cathode material.

When Example 2 is expressed as three-phase mole fraction phase (%, regenerated structure)=layered structure (x): spinel structure (y): rock salt structure (z), it may be expressed as 100>x>96, 2 >y >0, 2 >z >0, which corresponds to the region labeled “Phase distribution range of Examples 1 and 2” near the layered structure on the three-phase diagram of FIG. 7. Examples 1 and 2 of such a regenerated structure may exhibit a 95 to 100% level of electrochemical performance almost equivalent to that of the existing normal cathode material.

The following reference identifiers may be used in connection with the drawings to describe various features of embodiments of the present invention.
a: Layered structure core
b: Spinel structure deterioration layer
c: Rock salt structure deterioration layer
10: First core region
20, 20′: Second core region
30: First reinforcement layer
40: Second reinforcement layer

What is claimed is:

1. A regenerated cathode active material comprising:
a first core region comprising a cathode active material in a layered crystal structure; and
a second core region enveloping at least a portion of the first core region, wherein the regenerated cathode active material has a first mole fraction of particles in the layered crystal structure of 0.96 to 1, has a second mole fraction of particles in a rock salt crystal structure of o to 0.02, and has a third mole fraction of particles in a spinel crystal structure of 0 to 0.02 based on the total cathode active material.

2. The regenerated cathode active material of claim 1, wherein:
the second core region comprises a first metal element;
the first metal element comprises at least one metal element selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W); and
a concentration gradient of the first metal element in the cathode active material rises in a stepwise manner based on a first boundary surface between the first core region and the second core region from a center of the first core region and gradually rises from a second boundary surface of the second core region toward an outer direction of the second core region.

3. The regenerated cathode active material of claim 1, further comprising a first reinforcement layer enveloping a portion of the second core region, wherein the first reinforcement layer comprises a first metal element, the first metal element comprising at least one metal element selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W).

4. The regenerated cathode active material of claim 3, wherein the first reinforcement layer comprises at least one metal element selected from the group consisting of B₂O₃, Li₂O—B₂O₃, Li₃BO₃, Li₂B₄O₇, Li₂B₂O₇, and Li₂B₈O₁₃.

5. The regenerated cathode active material of claim 3, wherein the first reinforcement layer has a thickness of 1 to 100 nm.

6. The regenerated cathode active material of claim 3, wherein:
the regenerated cathode active material further comprises a second reinforcement layer enveloping a portion of the first reinforcement layer;
the second reinforcement layer comprises a second metal element; and
the second metal element includes at least one metal element selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W).

7. The regenerated cathode active material of claim 1, wherein the regenerated cathode active material has a specific surface area of 1.5 m²/g or less.

8. The regenerated cathode active material of claim 1, wherein the regenerated cathode active material has a particle strength of 80 MPa or more.

9. The regenerated cathode active material of claim 1, wherein a content of a residual lithium by-product in the regenerated cathode active material is less than 1.5% by weight based on a total weight of the cathode active material.

10. A method for preparing a regenerated cathode active material, the method comprising:
mixing a waste battery with a solvent after crushing the waste battery to a first particle size to form a mixture;
first precipitating the mixture to form a first precipitate;
second precipitating the first precipitate after crushing the first precipitate to a second particle size to form a second precipitate;
pressurizing the second precipitate so that the second precipitate has a moisture content of a predetermined % or less;
obtaining a black powder comprising a waste cathode active material by drying the pressurized second precipitate; and
performing a primary heat treatment after mixing the black powder with a lithium precursor to form a primary heat treatment resulting product.

11. The method of claim 10, wherein the waste battery includes at least one selected from the group consisting of lithium nickel cobalt manganese oxide (LiNiCoMnO₂; NCM), lithium nickel cobalt aluminum oxide (LiNiCoAlO₂; NCA), lithium iron phosphate (LiFePO₄; LFP), lithium manganese iron phosphate (LiMnFePO₄; LMFP), lithium manganese oxide (LiMn₂O₄; LMO), lithium nickel manganese spinel (LiNi_{0.5}Mn_{1.5}O₄; LNMO), and lithium cobalt oxide (LiCoO₂; LCO) series.

12. The method of claim 10, wherein the solvent includes at least one selected from the group consisting of water, methanol, ethanol, and acetonitrile.

13. The method of claim 10, wherein mixing the waste battery crushed to the first particle size with the solvent is performed at 60 to 100° C. for 2 to 24 hours.

14. The method of claim 10, wherein performing the primary heat treatment comprises mixing 1 to 30% by weight of the lithium precursor based on a total weight of the black powder.

15. The method of claim 10, wherein performing the primary heat treatment is performed at 200 to 1,000° C. for 3 to 24 hours in an oxygen atmosphere.

16. The method of claim 10, wherein performing the primary heat treatment comprises performing the primary heat treatment after mixing the black powder with the lithium precursor and a first metal element precursor, wherein the first metal element precursor includes at least one metal element selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W).

17. The method of claim 10, further comprising:
crushing the primary heat treatment resulting product;
mixing the crushed primary heat treatment resulting product with a second metal element, wherein the second metal element includes at least one selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W); and
performing a secondary heat treatment.

18. The method of claim 10, wherein the regenerated cathode active material has a specific surface area of 1.5 m²/g or less and wherein the regenerated cathode active material has a particle strength of 80 MPa or more.

19. The method of claim 10, wherein a content of a residual lithium by-product in the regenerated cathode active material is less than 1.5% by weight based on a total weight of the regenerated cathode active material.

20. The method of claim 10, wherein the regenerated cathode active material comprises:
a first core region comprising a cathode active material in a layered crystal structure; and
a second core region enveloping a portion of the first core region, wherein the second core region comprises a first metal element, wherein the first metal element includes at least one selected from the group consisting of boron (B), zirconium (Zr), titanium (Ti), aluminum (Al), magnesium (Mg), manganese (Mn), cobalt (Co), nickel (Ni), niobium (Nb), tantalum (Ta), and tungsten (W), and wherein a concentration gradient of the first metal element in the cathode active material rises in a stepwise manner based on a first boundary surface between the first core region and the second core region from a center of the first core region and gradually rises from a second boundary surface of the second core region toward an outer direction of the second core region.
